(19) United States
(12) Patent Application Publication
(10) Pub. No.: US 2013/0174555 A1
(43) Pub. Date: Jul. 11, 2013

(54) ELECTRIC POWER STATION

(71) Applicant: GE Jenbacher GmbH & Co OG, Jenbach (AT)

(72) Inventors: Friedrich GRUBER, Hippach (AT); Johann KLAUSNER, St. Jakob i.H. (AT)

(73) Assignee: GE Jenbacher GmbH & Co OG, Jenbach (AT)

(21) Appl. No.: 13/783,864

(22) Filed: Mar. 4, 2013

Related U.S. Application Data
(63) Continuation of application No. PCT/AT2011/000361, filed on Sep. 2, 2011.

(30) Foreign Application Priority Data
Sep. 6, 2010 (AT) A 1480/2010

(51) Int. Cl. F02B 63/04

(52) U.S. Cl. CPC F02B 63/04
USPC 60/698

(57) ABSTRACT

The invention relates to a power station comprising at least two generators (3, 3′) for generating electricity, wherein a gas turbine (1) is provided for driving one of the at least two generators (3, 3′), and a reciprocating piston engine (2) is provided for driving the other of the at least two generators (3, 3′). According to the invention, the reciprocating piston engine (2) comprises at least one charge air inlet (21) for precompressed charge air, and the gas turbine (1) comprises at least one compression stage (11), the at least one charge air inlet (21) of the reciprocating piston engine (2) being connected to an exit of the at least one compression stage (11) via a charge air line (41).

The present invention relates to a power station unit or a power station, having at least two electric generators for generating electricity, wherein a gas turbine is provided for driving one of the at least two generators and a reciprocating piston engine is provided for driving the other of the at least two generators, wherein the reciprocating piston engine has at least one charge-air inlet for precompressed charge air and the gas turbine has at least one compression stage.

The present invention is preferably directed towards stations for generating electricity of 10 to 100 MW electrical output, wherein the load can be varied between 30% and 115% of the full load.

### STATE OF THE ART

U.S. Pat. No. 3,498,053 (Johnston) describes a reciprocating piston engine/turbine combination in which exhaust gas is fed from the reciprocating engine to the turbine and the turbine drives a compressor which in turn supplies compressed air for supercharging and cooling the reciprocating engine. Here, the entire mass flow of the compressor/turbine assembly is guided via the reciprocating engine. The turbine does not have a combustion chamber of its own.

EP2096277A1 (MAGNETI MARELLI) describes a supercharged internal-combustion engine wherein turbine (13) and compressor (14) of the charging system are mechanically independent. Here too, the supercharging unit is not capable of delivering power via a combustion chamber of its own.

U.S. Pat. No. 3,444,686 (Ford Motors) describes an arrangement of engine and gas turbine in which the engine exhaust gases are mixed with the turbine exhaust gases in order to reduce pollutants. Use of compressed air from the compressor (16) in the internal combustion engine (12) is not provided.

In the power segment in question, gas turbine stations, combined cycle power plants (CCPPs) and gas or diesel engine stations are generally used.

These technologies each have different merits and disadvantages, with the result that the selection is limited accordingly depending on requirements or boundary conditions.

Thus the advantages of a pure gas turbine station are a high power density and the specific investment costs, which reduce as output increases, as well as the low costs of service and maintenance. The low efficiency compared with a CCPP is disadvantageous.

CCPPs in turn have very high efficiencies of up to approx. 60%, but can only be realized cost-effectively for stations above approx. 200 MW output. Moreover, their behavior under partial load is disadvantageous.

Gas engine stations are very cost-effective for power station outputs of up to approx. 100 MW. They have high full load and partial-load efficiencies and can react rapidly to changes in load requirements. If, in addition to electricity generation, the engine waste heat is also used, overall efficiencies (electric+thermal) of up to 90% can be achieved.

One of the disadvantages of gas engine stations are the relatively high costs of service and maintenance and the relatively large specific space requirements.

EP 1 990 518 A2 and U.S. Pat. No. 6,282,897 B1 disclose arrangements having at least two electric generators for generating electricity, wherein a gas turbine is provided for driving one of the at least two generators and a reciprocating piston engine is provided for driving the other of the at least two generators, wherein the reciprocating piston engine has at least one charge-air inlet for precompressed charge air and the gas turbine has at least one compression stage.

EP 1 990 518 A2 deals with a special drive system for aircraft since a particular problem with aircraft is that a stall in the turbine can occur at low speeds and high pitch angles (e.g. during the take-off phase).

U.S. Pat. No. 6,282,897 has the object of increasing the range of a vehicle with hybrid propulsion system.

It is clear that the teachings of these citations are not relevant with respect to a stationary power station unit according to the invention.

The object of the invention is to further develop a generic power station unit such that the most advantageous way of generating electricity is accomplished.

This object is achieved by a power station unit with the features of claim 1.

Further advantageous embodiments are defined in the dependent claims.

A possible mode of operation of the power station unit according to the invention could be as follows, wherein it is assumed below in a simple manner that a reciprocating piston engine is in the form of a gas engine:

The gas engine and the gas turbine each drive a generator, which generators feed the electricity generated into the consumer grid.

Starting from stopped mode of the station, the commissioning, start-up and ramping up are performed for example in the following way:
The engine is started and accelerated to rated speed and synchronized with the grid; the start-up preparation procedure for the gas turbine runs at the same time. In parallel operation with the grid, the engine is accelerated to the maximum suction power (approx. 15% of full load).
The gas turbine is accelerated to rated speed; in accordance with the thus-increasing charge pressure, the engine accelerates with the load.
The generator of the gas turbine is synchronized with the grid and the combustion chamber(s) are activated.

The fuel is supplied to the combustion chamber(s) depending on output requirements in such a way that optimum efficiency or maximum possible output is achieved.

For optimum adaptation of the compressor delivery to the gas turbine output or to the operating requirements, inlet guide vanes are advantageously used upstream of the compressors.

The air quantity for the gas engine is preferably adjusted and optimized by one or more throttle valve(s) (e.g. throttle flap(s)), wherein throttling should be avoided as far as possible in stationary full load operation.

To regulate the output of the turbine, the fuel supply to the turbine combustion chambers is varied.

The output of the unit should in principle be above approx. 75% of the full load in order to achieve optimum efficiency.

In the case of output requirements below 75%, modular power station complexes with a number of individual power station units as smaller output units prove very advantageous, wherein the reduced outputs can be achieved in the respective full load operation of part of the power station units while the remaining parts are switched off.

After the power station unit consisting of gas engine and gas turbine has been started and ramped up, said power station unit is operated in an output range between approx. 60 and approx. 115% of full load output, wherein the 115% correspond to the overload that can be achieved for a short time to cover consumption peaks.

To achieve maximum efficiency, it is advantageous if the gas turbine has a high-pressure combustion chamber (HP combustion chamber) and a low-pressure combustion chamber (LP combustion chamber), wherein the energy supplied to the turbine burners is preferably divided up in such a way that a high-pressure combustion chamber receives approx. ¾ and the low-pressure combustion chamber receives approx. ¼ of the quantity of gas supplied to the turbine station.

The energy supplied to the high-pressure combustion chamber is limited by the maximum permissible gas temperature for entry into the turbine, wherein the combustion air ratio and final compression temperature are the most important parameters influencing the gas temperature.

The unit is switched off in an opposite manner to the ramping-up procedure, wherein the energy supply to the burners is interrupted and the turbine generator is taken off the grid.

The output of the gas engine is throttled via the throttle valves for the air and gas. To reduce the load on the gas engine more rapidly, a pressure relief line with shut-off valve is provided that ensures rapid pressure release in the mixture-distribution line of the engine.

To reduce the NOx concentration in the engine exhaust gas, in an embodiment example the injection of a reducing agent into the engine exhaust gas is provided, wherein the reducing agent is mixed with the exhaust gas in a mixing section and after heating triggers a thermally supported reduction reaction with the NOx. The NOx can thus be reduced to a level such that the limits provided for gas turbines are not exceeded.

Further advantages resulting from the proposed integration of gas engine and gas turbine include the following:

The gas engine can support and shorten the start-up and ramping-up procedure of the gas turbine. For example, the engine exhaust gas heats the LP combustion chamber and LP turbine and preheats the HP combustion chamber via the recuperator.

In the case of short interruptions to the grid, the relatively high moment of inertia of the turbine rotor keeps the engine within the permissible frequency limits (grid codes).

In the low-pressure combustion chamber, the CO and HC emission of the gas engine is eliminated without catalytic aftertreatment.

With regard to the electrical output generated, the quantity of exhaust gas is less than in pure gas turbine stations or CCPPs.

This has advantages for the dimensioning of the exhaust gas station and with respect to minimization of the exhaust gas loss.

### Embodiment Example

Air intake quantity of the LP compressor: 113 kg/sec
Pressure after the LP compressor (4a): 8 bar
Power input of the LP compressor: 28.6 MW
Quantity of air supplied to the engine: 22.6 kg/sec
Energy supplied to the engine: 31 MW
Output of the gas engine: 15 MW
Exhaust gas temperature of the engine: 680° C.
Quantity supplied by the HP compressor: 90 kg/sec
Pressure after HP compressor: 25 bar
Power input of the HP compressor: 12.8 MW
Fuel energy supplied to the HP combustion chamber: 90 MW
Temperature after HP combustion chamber: 1300° C.
Pressure after HP turbine: 7 bar
Temperature after HP turbine: 950° C.
Mechanical power output of the HP turbine: 39.5 MW
Mass flow through the LP combustion chamber: 115 kg/sec
Fuel energy supplied to the LP combustion chamber: 25 MW
Temperature after LP combustion chamber: 1060° C.
Temperature after LP turbine: 630° C.
Power output of the LP turbine: 60.7 MW
Mechanical net output of the power station unit: 74 MW
Mechanical efficiency of the power station unit: 50.5%

The output of the turbine station can be increased, for example, by increasing the energy supplied to the low-pressure combustion chamber. This is possible since the turbine inlet temperature here is still significantly below the temperature limit permitted for the material of the turbine blades. Although this measure somewhat reduces the efficiency of the turbine process, this disadvantage can be more than outweighed by the advantage of the increased efficiency, for example for covering consumer peaks, for more rapid increase in output or for compensating for reductions in output at very high external temperatures.

Referring to the numerical example mentioned above, an increase in the fuel energy supplied to the LP combustion chamber
from 25 MW to 50 MW
   results in an increase in the net output of the power station unit
from 74 MW to 84 MW
   with simultaneous decrease in the total mechanical efficiency
from 50.5% to 48.6%

Further advantages and details of the invention are apparent from the figures and the associated description of the figures. There are shown in:

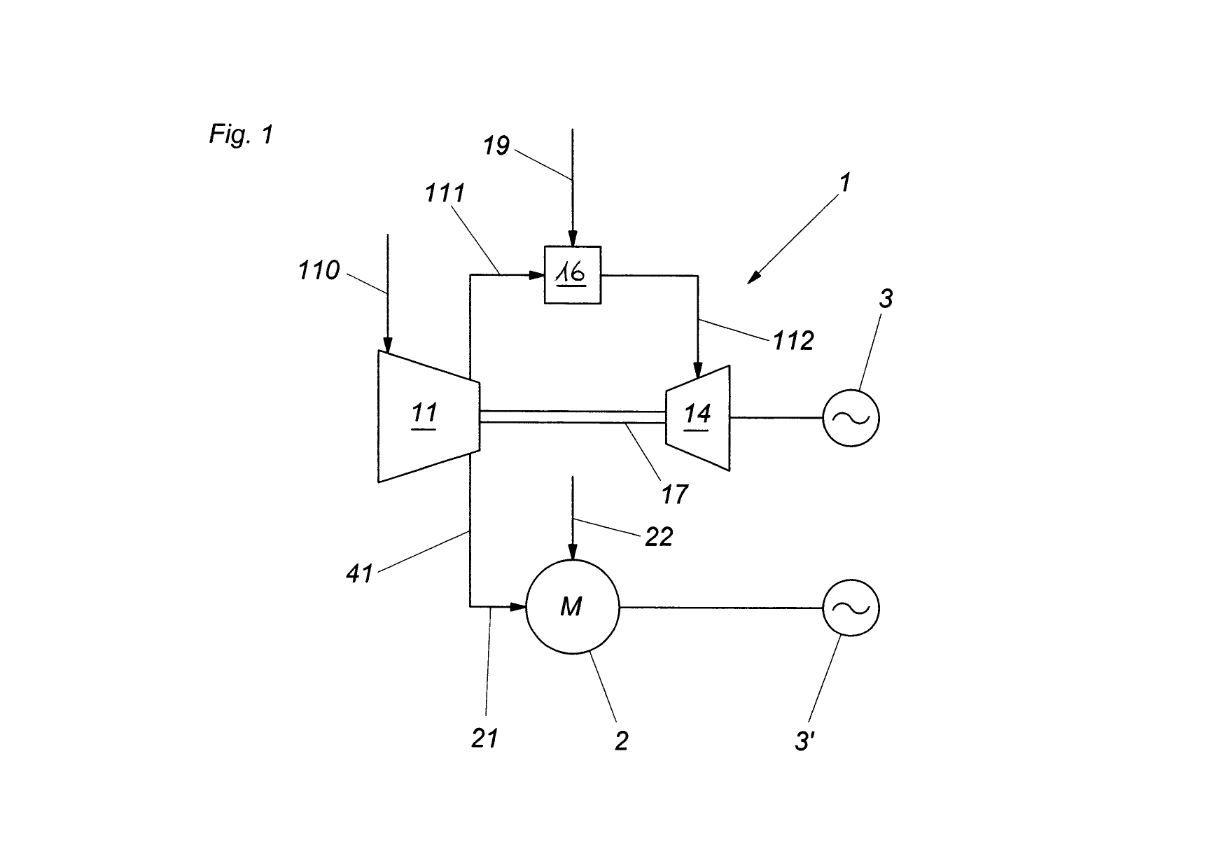

FIG. 1 a schematic view of a power station unit according to the invention in a first embodiment,

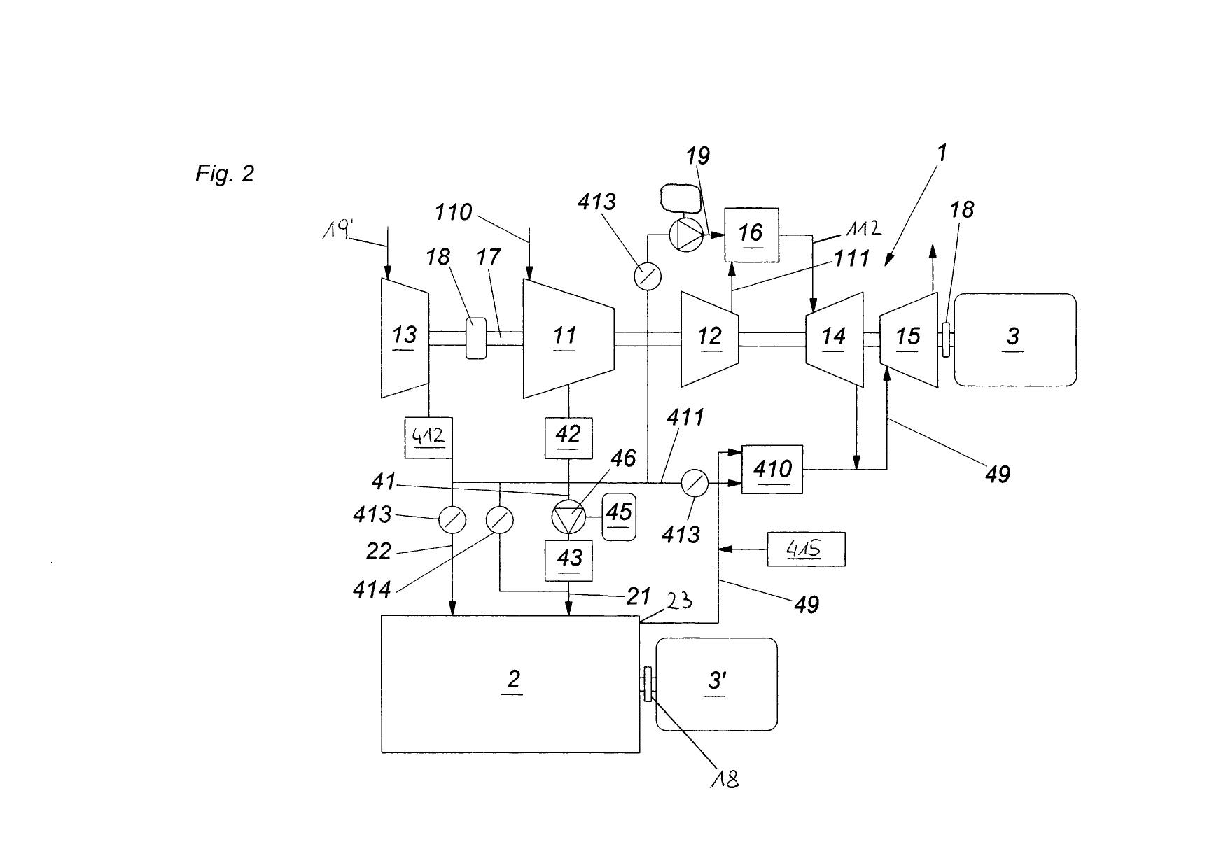

FIG. 2 a schematic view of a power station unit according to the invention in a second embodiment and

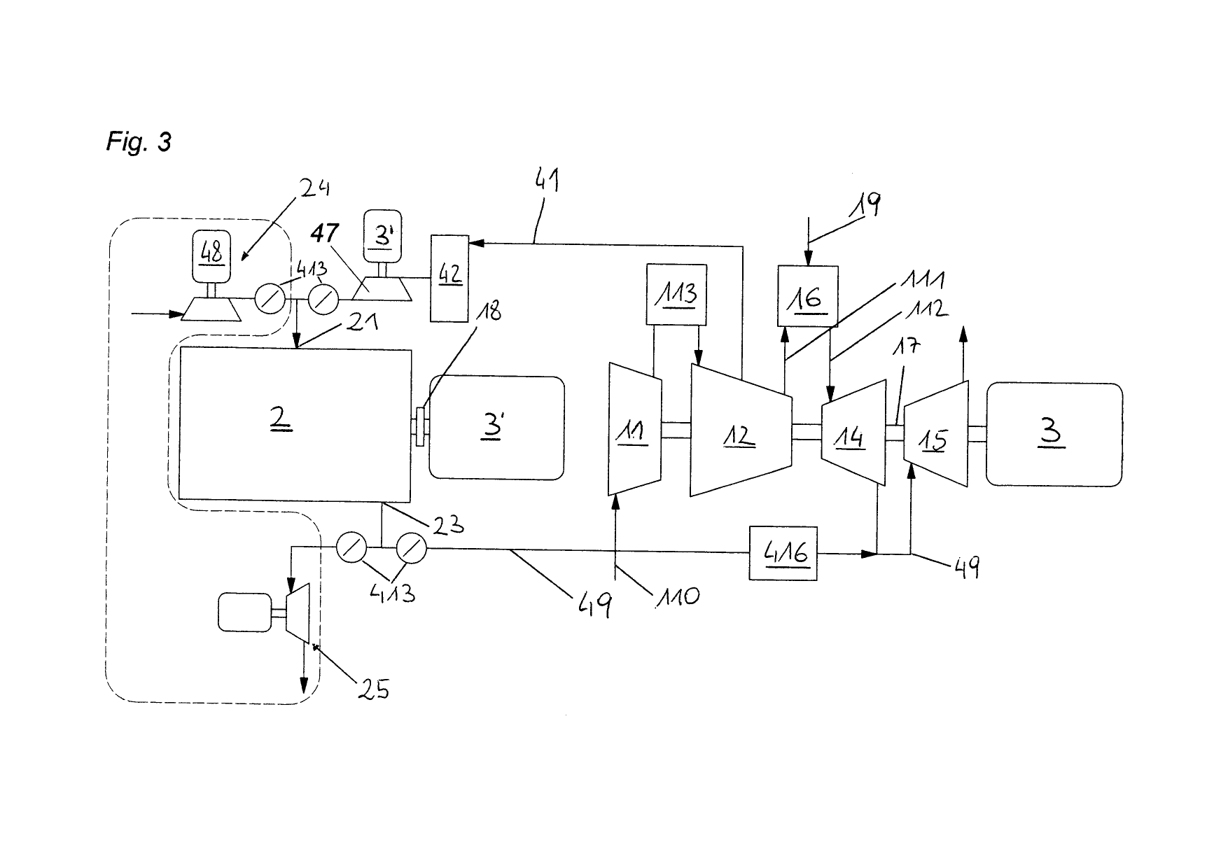

FIG. 3 a schematic view of a power station unit according to the invention in a third embodiment.

FIG. 1 shows a power station unit according to the invention having a gas turbine 1 and a reciprocating piston engine 2, which is formed here as a gas engine. The gas turbine 1 drives an electric generator 3 for generating electricity. The reciprocating piston engine 2 drives a further electric generator 3′ likewise for generating electricity.

The gas turbine 1 is designed per se according to the state of the art and has at least one compression stage 11 and an expansion stage 14, which are connected to each other here by a common shaft 17 for the transmission of a rotational movement. The invention can of course also be used if, instead of a single common shaft 17, coupled rotating components are provided.

Ambient air is supplied to the compression stage 11 via a line 110. Said compression stage 11 compresses the ambient air and conveys part of the compressed air to a turbine combustion chamber 16 via a line 111. The turbine combustion chamber 16 furthermore has a propellant supply 19. In a manner known per se, a further line 112 leads from the turbine combustion chamber 16 to the expansion stage 14, where the medium is relieved of pressure and power is delivered.

The reciprocating piston engine 2 is also provided with a gas line 22 via which propellant can be supplied to the engine. The reciprocating piston engine 2 furthermore has a charge-air inlet 21, which according to the invention is connected to an exit of the compression stage 11 via a charge-air line 41. In this way the charge air required to operate the reciprocating piston engine 2 is provided via the gas turbine 1. Exhaust gas can be discharged via an exhaust gas exit 23, not shown in FIG. 1.

FIG. 1 shows the path of the charge-air line 41 starting from the end of the compression stage 11. In practice the variant shown in the other figures, in which the charge-air line 41 branches off from the compression stage 11 in an intermediate area of the latter, will be more realistic. The location of the branch-off is advantageously selected such that the charge air at the branch off already has the charge pressure required for the reciprocating piston engine 2 (the pressure changes in the compression stage in a known manner).

The power station unit of FIG. 2 essentially corresponds to that of FIG. 1, but advantageous measures are additionally provided, such as for example the arrangement of coolers 42, 43 for the charge air and 412 for the propellant.

The gas turbine 1 here has a first compression stage 11 and a second compression stage 12, as well as a first expansion stage 14 and a second expansion stage 15. The unit just discussed consisting of the compression stages 11, 12 and the expansion stages 14, 15 is arranged along a common shaft 17. A generator 3 for generating electricity and a gas compressor 13 for compressing the propellant supplied via the propellant supply 19′ are coupled to the shaft via gearbox 18. The propellant compressed by the gas compressor 13 is cooled via a cooler 412 before it is supplied on the one hand to the turbine combustion chamber 16 via a throttle flap 413 and the line 19 and on the other hand to the gas engine 2 via a further throttle flap 413 and the line 22. Propellant which is used to further treat exhaust gas from the reciprocating piston engine 2 (see description below) can also be supplied to a reaction chamber 410 via a further throttle flap 413 and the line 411. For aftertreatment of the exhaust gas, a reducing agent can additionally be added via the reducing agent supply 415.

The embodiment of FIG. 2 differs from that of FIG. 1 in one important aspect, namely that the reciprocating piston engine 2 has an exhaust gas exit 23, wherein an exhaust gas line 49 opens out into the transition from the high-pressure stage 14 to the low-pressure stage 15 of the gas turbine 1. In this way the efficiency of the arrangement according to the invention can additionally be increased. Advantageously, it is provided that the exhaust gas of the reciprocating piston engine 2 is treated in a reaction chamber 410. Propellant can also be supplied to said reaction chamber 410 via a line 411 in order to increase the temperature. A reactant can be added to the exhaust gas in the exhaust gas line 49 via a reactant supply 415. In the transitional area between the high- and low-pressure stages 14, 15 into which the exhaust gas of the engine is introduced, there is a pressure level that corresponds to an energetically favorable exhaust gas back pressure.

A number of throttle flaps 413, which can be used to throttle the respective media, can also be seen in FIG. 2. A gearbox 18 for rotational speed adjustment can also be seen.

To reduce the load on the reciprocating piston engine 2 more rapidly, a pressure relief line with a shut-off valve 414 is additionally provided here via which rapid pressure release in the mixture distribution of the reciprocating piston engine 2 can be achieved.

In the present embodiment example, the reciprocating piston engine 2 has a mean effective pressure of 30 bar and an efficiency of 48%.

The first turbine stage 14 is designed as a high-pressure turbine. The second turbine stage 15 is designed as a low-pressure turbine.

A further advantageous embodiment of the invention is evident from FIG. 3. This differs from the previous embodiment example in that, firstly, a connectable and disconnectable supercharging system 24 and a connectable and disconnectable exhaust gas turbine 25 are provided with respect to the reciprocating piston engine 2. These enable the reciprocating piston engine 2 to operate even when the gas turbine 1 is not running. When the gas turbine 1 is in operation, these additional systems 24, 25 can be disconnected. A propellant supply 19′, which is of course present, is not shown. The exhaust gas can be heated by an exhaust gas heater 416 before it is supplied to the turbine stage 15. Secondly, between the charge-air line 41 that runs from the gas turbine compressor 12 to the reciprocating piston engine 2, an intercooler 42 and an expansion turbine 47 are provided here which lead to further cooling of the charge air and thus facilitate extremely high outputs of the reciprocating piston engine 2. The output of the expansion turbine 47 can, for example, be converted into electric current by a generator 3′ and fed into the grid.

Some data for the embodiment of FIG. 3:

The reciprocating piston engine 2 has a mean effective pressure of 35 bar here, which corresponds to an output of 17.5 MW with the piston displacement and rotational speed of the engine used. The efficiency is again approx. 48%.

In a specific embodiment example, precompressed air with a pressure of 20 bar is supplied to the turbine combustion chamber 16 at a temperature of 335° C. The quantity of gas supplied to the combustion chamber corresponds to an output of 90 MW. The inlet temperature in the high-pressure expansion stage (turbine 14) is approx. 1100° C. The medium leaves the first expansion stage 14 with a pressure of 7 bar and a temperature of 830° C. Exhaust gas leaves the second expansion stage (low-pressure turbine) 15 with a temperature of 450° C. The achievable net output is 33.1 MW with an efficiency of 39%.

The overall system thus has an output of 50.6 MW with an efficiency of 42%.

1. A power station unit comprising at least two electric generators for generating electricity, wherein a gas turbine is provided for driving one of the at least two generators and a reciprocating piston engine is provided for driving the other of the at least two generators, wherein the reciprocating piston engine has at least one charge-air inlet for precompressed charge air and the gas turbine has at least one compression stage, characterized in that the at least one charge-air inlet of the reciprocating piston engine is connected to an exit of the at least one compression stage via a charge-air line.

2. The power station unit according to claim 1, wherein the charge-air line runs between the exit of the at least one compression stage and the charge air inlet of the reciprocating piston engine through at least one, preferably through two coolers.

3. The power station unit according to claim 1, wherein the gas turbine has at least two compression stages and charge air with different pressure levels is fed from different compression stages to the reciprocating piston engine.

4. The power station unit according to claim 1, wherein the reciprocating piston engine is a gas engine.

5. The power station unit according to claim 4, wherein the reciprocating piston engine has a gas inlet for supplying propellant and the gas inlet is connected to a gas compressor driven by the gas turbine via a gas line.

6. The power station unit according to claim 1, wherein the charge-air line between the exit of the at least one compression stage and the charge-air inlet runs via a compressor stage driven by an electric motor, wherein the extent of the pressure increase is controlled or regulated by the rotational speed of the electric motor.

7. The power station unit according to claim 2, wherein the charge air for the reciprocating piston engine is directed after recooling by the at least one cooler via an expansion turbine, which drives an electric motor, with the result that further cooling of the charge air can be achieved according to the principle of the external Miller process.

8. The power station unit according to claim 1, wherein the reciprocating piston engine has an exhaust gas exit and the gas turbine has at least two expansion stages, wherein exhaust gas can be introduced via the exhaust gas exit and an exhaust gas line between the at least two expansion stages of the gas turbine.

9. The power station unit according to claim 8, wherein the exhaust gas line runs between the exhaust gas exit of the reciprocating piston engine and the at least one expansion stage of the gas turbine via a reaction chamber, wherein a line is configured to additionally feed propellant compressed by one of the at least one compression stages to the reaction chamber.

10. The power station unit according to claim 1, wherein the power station unit is configured to feed precompressed charge air from a compressor stage of the gas turbine—optionally via a combustion chamber—to an expansion stage of the gas turbine.

11. The power station unit according to claim 2, wherein the power station unit is configured to feed—preferably uncooled—compressed air (charge air) to an expansion stage of the gas turbine between the expansion stages.

12. The power station unit according to claim 1, wherein a connectable separate charging system is provided for the reciprocating piston engine, with the result that said reciprocating piston engine is also operational when the gas turbine is stopped.

13. The power station unit having an arrangement according to claim 1.

14. The power station unit according to claim 13, wherein at least two reciprocating piston engines are provided for each gas turbine, of which each reciprocating piston engine drives a generator of its own.

15. A power station having at least two power station units according to claim 13.
